(19) United States
(12) Patent Application Publication
(10) Pub. No.: US 2013/0301938 A1
(43) Pub. Date: Nov. 14, 2013

(54) HUMAN PHOTO SEARCH SYSTEM

(71) Applicants: Yin-Ying Chen, Taipei (TW); Yu-Heng Lei, Taipei (TW); Winston H. Hsu, Taipei (TW)

(72) Inventors: Yin-Ying Chen, Taipei (TW); Yu-Heng Lei, Taipei (TW); Winston H. Hsu, Taipei (TW)

(73) Assignee: NATIONAL TAIWAN UNIVERSITY, Taipei (TW)

(21) Appl. No.: 13/599,127

(22) Filed: Aug. 30, 2012

(30) Foreign Application Priority Data
May 11, 2012 (TW) 101116802

(51) Int. Cl. G06K 9/62

(52) U.S. Cl. 382/224

(57) ABSTRACT

A human photo search system is provided. A user can search for a human photo using a canvas interactive interface on a user device, such as a touch panel or a computer. The user composes his/her impression of a desired photo on a query canvas to generate query semantics, which are then sent to a photo search server. The photo search server then searches a human photo database for candidate photos corresponding to the query semantics, and ranks the candidate photos according to relevance. Finally, the photo search server sends the sorted candidate photos back to the user device for display. Accordingly, the human photo search system of the present invention can search possible photos by the positions, the sizes, and the human attributes of the people in the desired photo, for which the user composes his/her impression on the query canvas without entering any text tags.

### FIELD OF THE INVENTION

The present invention relates to human photo search systems, and, more particularly, to a human photo search system applicable to a user device for searching a large-scale human photo database.

### BACKGROUND OF THE INVENTION

With the growth of digital equipment and technology, digital photography is already a part of daily life. Different from traditional film-type photos, digital photos can be stored in electronic devices. Digital photos have the advantages of low-cost, easy to be carried and no restrictions on the number and capacity, making digital photos an important tool for people to record their daily life.

Due to the low cost of the digital photos and virtually no limit on storage space, people generally own a huge number of digital photos, making it difficult to find specific photos from digital “albums.” Comparison of text tags has now been commonly used for searching photos. Although text-based searching is highly accurate, there are still some drawbacks. For example, photos have to be manually tagged and the tagging process is tedious. Sometimes the text tags do not accurately describe the details, such as attributes or layout of people in the photos, making it difficult to search accurately if a user cannot remember the exact text tag, especially in the case where the user has only a vague impression of the specific photo, so text tagging alone cannot achieve a satisfactory search result. Specifically, when people have little memory of the photo content, for example, and he/she may have forgotten when, where or with whom the photo was taken, it is almost impossible to search using its text tag. People may very often forget the detailed content but still possess a vague memory of what the photo looked like, for example, how many people, who is in the photo, the layout of the people in the photo, or even just some of the people in the photo. With such impression, it is not possible to conduct a search using text tags or through prior classification, thus rendering the existing photo search methods impractical in these kinds of situations.

TW patent application No. 200900970 discloses a human image search method, a system, and a recording media for storing image metadata. It is essentially a photo search system based on face identity recognition, and requires prior manual training by users to process searched data. Its disadvantages reside in that: (1) since the category to be identified is the identity of certain unknown person, preparation and manual tagging of training data in advance are necessary; and (2) the training process is time-consuming. In view of the above, the existing technique clearly has room for improvement, especially when searching through photos without knowing the exact content of the target photo. Furthermore, U.S. Pat. No. 5,751,286 discloses an image search system and method for providing search for photos of general objects, allowing users to compose the photo content as the basis for search. Although this technique can automatically compute image features, it still requires users to manually define (e.g., highlight) important objects in a photo, that is, no automatic detection can be provided to complete the pre-processing of the photos, so the processing of the photos is very cumbersome. Furthermore, this technique performs searches by comparing every image in the database one by one, and is very time-consuming. In other words, even if a photo can be composed by the user, finding the desired photo among a huge amount of data is still not a simple task.

Therefore, there is a need to develop a quick and highly reliable photo search mechanism, especially for photos that are not tagged by users and are only of vague impression to them. The search mechanism should only require users to have a vague impression of the photos, and provide intuitive, easy-to-use, accurate, and real-time search to find photos whose contents are not fully known to the users. This will help users in searching for a desired human photo/one on which users have only a vague impression through a large collection of human photos.

### SUMMARY OF THE INVENTION

In light of the foregoing drawbacks, an objective of the present invention is to provide a human photo search system that searches a desired photo/a photo with only a vague impression based on the positions, the sizes and the attributes of the people in photos.

Another objective of the present invention is to apply on user electronic devices, enabling intuitive and simple operations for composing the search intention for the desired photo as search basis through a user interface such as multi-touch screen or a mouse.

In accordance with the above and other objectives, the present invention provides a human photo search system, which includes a user device and a photo search server connected together by a network. The user device includes a canvas interactive interface. The canvas interactive interface includes a query canvas area for allowing a user to compose and set human content and human layout therein to generate query semantics. The photo search server includes: a human photo database, a search module, a ranking module, and a display module. The human photo database is used for storing a plurality of human photos and building a block-based index based on position and size information. The search module is used for receiving the query semantics from the user device and retrieving candidate photos pointed to by the block-based index of the human photo database based on the query semantics. The ranking module is used for generating a score for each of the candidate photos based on relevance, and sorting all of the candidate photos according to the scores therefor. The sorted candidate photos are returned back to the user device by the display module.

In an embodiment, the human content in the query semantics may include at least one selected from the group consisting of gender, age, race, facial expression, hairstyle, accessories and the like, and the human layout in the query semantics includes positions, sizes, angles and the number of people in the query canvas area.

In another embodiment, the block-based index includes human attribute scores, facial appearance similarity scores, and photo aesthetic scores. Through a human attribute detection module, a facial appearance similarity estimation module, and an aesthetics assessment module, the human photo is analyzed to generate scores of each person or of the entire photo.

In yet another embodiment, the photo search server further includes an aesthetic filtering module that performs filtering on the aesthetic scores of the candidate photos, such that the display module displays only those candidate photos with aesthetic scores higher than a predetermined value.

Compared to the prior art, the present invention provides a human photo search system that allows the user to compose (edit and set) the search intention for the desired photo using the canvas interactive interface of the electronic device, and search the block-based index based on the query semantics (search criteria) to find candidate photos that match the query semantics. By relevance ranking and optional aesthetic filtering, candidate photos with higher relevance to the canvas composition and optionally better aesthetic quality are displayed. With the human photo search system of the present invention, the user only needs to edit the human layout or set the human attributes in order to find a photo, which is more intuitive and easier to use than searching using only text tags. This is particularly useful if the user only has a vague impression of the photo.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram illustrating a human photo search system according to the present invention;

FIG. 2 is a schematic block diagram illustrating another embodiment of the human photo search system according to the present invention;

FIG. 3 is a schematic diagram illustrating a canvas interactive interface of the human photo search system according to the present invention; and

FIGS. 4A-4D are schematic diagrams illustrating various operating patterns of the human photo search system according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

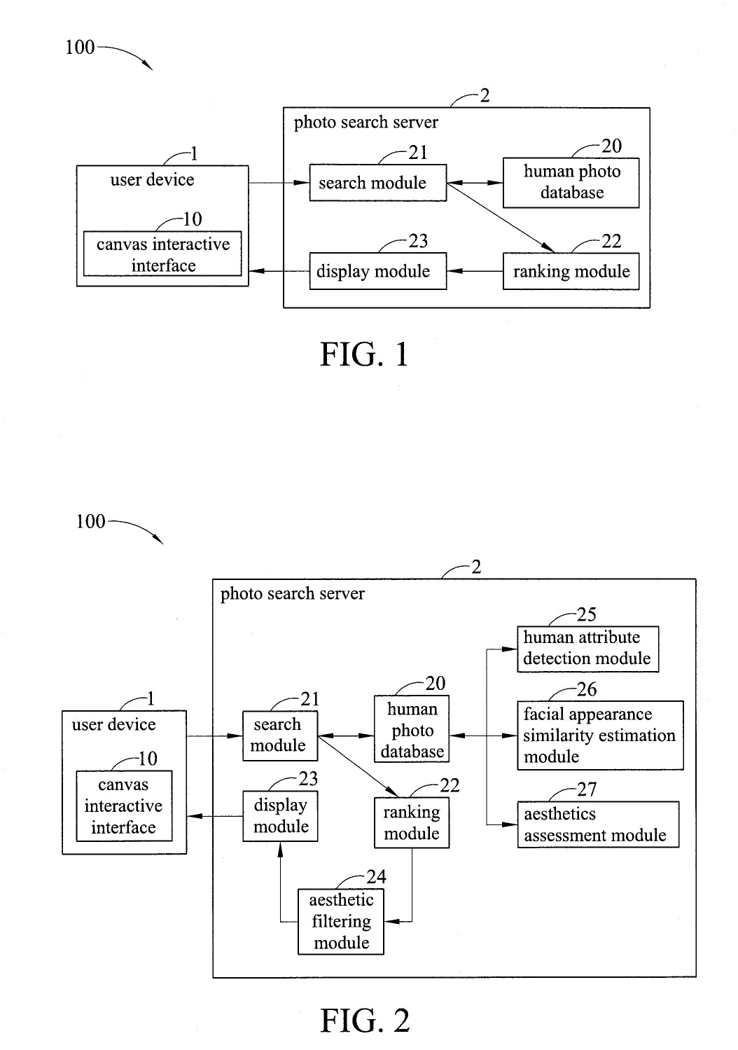

Referring to FIG. 1, a schematic block diagram illustrating a human photo search system 100 according to the present invention is shown. The human photo search system 100 includes a user device 1 and a photo search server 2, allowing a user to search a desired photo/a photo with only a vague impression using the photo search server 2 via the user device 1.

The user device 1 may include, but not limited to, a touch-sensitive device and a computing apparatus, and has a canvas interactive interface 10. The canvas interactive interface 10 has a query canvas area that allows the user to compose (edit and set) the human content and the human layout of a desired photo in order to generate query semantics. More specifically, the user device 1 can be an electronic device with a touch screen, such as a smart phone, a touch-sensitive computer, a touch-sensitive wall, a touch-sensitive table and the like. The user uses the canvas interactive interface 10 to perform human photo searches. In contrast to the conventional text tagging, the present embodiment performs searches by composing pictures. Thus, the canvas interactive interface 10 provides a query canvas for composition. In the query canvas area, the user may edit and set information about the people of the desired photo, for example, the number, the approximate position(s), or some attributes of the people, to generate the query semantics.

In a specific embodiment, the query semantics include the human content and the human layout of the desired photo. The human content may be some human attributes, such as gender, age, race, facial expression, hairstyle, accessories or a combination of the above. Moreover, the human content may also include a facial photo selected from candidate photos or input by the user. In other words, in the case of searching for a specific person known by the user, apart from performing composition using the canvas interactive interface 10 as just mentioned, the user may simply select a facial photo from the candidate photos in the previous search results or input the facial photo himself/herself. In such a case, the search criterion is based on facial appearance similarity. The human layout may indicate the position, the size, the angle, and the number of people in the query canvas area, or a combination of the above. Therefore, in addition to searching for the possible position and the size of a person in the desired photo composed in the query canvas area, the user may also set the human content of the photo for use as query semantics in the subsequent searches.

In this embodiment, the photo search server 2 is connected to the user device 1 through a network. A large number of photos are stored in the photo search server 2, so there is no need to store any photos in the user device 1. This is similar to a cloud database in the current cloud computing technology, and it also illustrates that the human photo search system 100 of the present invention can be applied to different environments. The photo search server 2 includes a human photo database 20, a search module 21, a ranking module 22 and a display module 23.

The human photo database 20 in the photo search server 2 is used to store a plurality of human photos, and to build a block-based index based on position and size information. In other words, a human photo can be spatially divided into a plurality of blocks at various positions and with various widths and heights. Based on the position and size of a person in the human photo, the range of the block in which the person appears is determined, and a block-based index is built for speeding up the search process. During the search, based on the composition specified by the user via the canvas interactive interface 10, blocks in which people appear are used as a basis for the search, and candidate photos matching the composition can be found by looking up the block-based index. In addition, apart from storing human photos that have been analyzed and indexed as mentioned before, the human photo database 20 may also store new photos that are unanalyzed, and human photos can be formed by performing content analysis and block-based indexing on the new photos. It should be noted that the generation of the block-based index and its associated information can be done by the photo search server 2 by automatically analyzing photos, and the conventional way of text tagging is not necessary, thus eliminating the need for manual typing or setting. Also, errors in search results caused by tagging ambiguity can be avoided. This provides great conveniences for users.

Furthermore, the block IDs in the block-based index are used as a basis for searching, in which the center coordinate and the width and height values of a person in the photo are used to determine the block in which the person or his/her face appears. This can be compared with the query semantics generated from the canvas composition for human layout comparison. The center coordinate and the width and height values of a person are represented relative to the width and height of the entire photo, so that a uniform comparison standard is provided for human photos with various aspect ratios (i.e., the height to width ratios) or resolutions. In addition, content analysis on the people or on the entire photo can also be performed to generate human attribute scores, facial appearance similarity scores, an aesthetic score, or the like. These scores can similarly be used as a basis for the search, which will later be discussed in more details. Furthermore, the present invention provides indexing of people using a block-based method to speed up the search.

For each block (“block” is a collective term for position and size) that may be selected by the user, the “block-based indexing” proposed by the present invention stores in advance the people appearing in this block and the corresponding attribute scores as index. Thus, fast searching in a database with a large quantity of data can be achieved. In an actual implementation, in a human photo database with over 200,000 photos, an average search time is less than 0.1 second. Compared with the method without indexing, this saves much search time.

Since retrieving only people in the block of the query person is still too sensitive, in order to increase accuracy, a sliding window approach is preferably adopted by computing the relevance scores for people in the neighboring blocks to assist the search process. In addition, as for the search process for multiple query people, each person is searched separately, and each query person can only match one person in a database photo.

The search module 21 receives the query semantics from the user device 1, and retrieves candidate photos pointed to by the block-based index based on the query semantics.

The ranking module 22 generates a score for each of the candidate photos based on relevance and sorts all of the candidate photos by their scores. The relevance score mentioned above takes into account the errors between the query semantics generated by the query canvas and the candidate photo. The errors may include: human attributes, facial appearances, the positions, the sizes, the angles, or the number of people, etc. Since there may be a plurality of candidate photos, the ranking module 22 sorts these photos according to their relevance to the query semantics, that is, the candidate photos that more closely match the query semantics are sorted in the front, and vice versa.

The display module 23 returns the sorted photos back to the user device 1, so that the user may see the sorted candidate photos on the canvas interactive interface 10 of the user device 1.

With the human photo search system 100, the user may be able to quickly and intuitively compose a picture from his/her impression of the desired photo, which then generates query semantics that is the compared with pre-processed database photos. Candidate photos that are similar to the query semantics are listed and sorted based on their relevance. If these candidate photos still deviate from the impression of the user, he/she may immediately modify the composition or settings in the query canvas of the user device 1 to generate new query semantics. After being processed again by the search module 21 and the ranking module 22, new results will be displayed, that is, sorted candidate photos corresponding to the new query semantics are returned by the display module 23.

Referring to FIG. 2, a block diagram illustrating another embodiment of the human photo search system according to the present invention is shown. As shown in FIG. 2, the human photo search system 100 is similar to that described in FIG. 1. The photo search server 2 similarly includes the human photo database 20 for storing human photos, the search module 21 for retrieving candidate photos, the ranking module 22 for arranging candidate photos in an order, and a display module 23 for displaying the search results. In this embodiment, the photo search server 2 of the human photo search system 100 further includes a human attribute detection module 25, a facial appearance similarity estimation module 26 and an aesthetics assessment module 27.

The human photos in the human photo database 20 are searched based on the information in a block-based index, and the block-based index is built from several analysis steps. What information is included the block-based index and how they are generated will be discussed. In this embodiment, the photo search server 2 uses the block-based index to reduce search range and thus increase search speed, thereby allowing the user to see the candidate photos in a short period of time.

The information in the block-based index may include human attribute scores, facial appearance similarity scores, and photo aesthetic scores. These data can be obtained by the human attribute detection module 25, the facial appearance similarity estimation module 26 and the aesthetics assessment module 27. In this embodiment, each query person may compare either human attributes or facial appearance similarity, and photo aesthetics is an optional consideration that makes the displayed results look better. However, the above comparison criteria should be interpreted in an illustrative rather than limiting sense. Preferably, a query may adopt the criteria of both human attributes and facial appearance similarity.

The human attribute detection module 25 performs attribute detection on a person in the human photo to generate attribute scores of the person. In this embodiment, a human attribute score may be of gender (male/female), age (e.g., kid, youth, elder), race (e.g., Caucasian, Asian, African), or the like. The above can be achieved by large-scale photo training using, for example, Support Vector Machines (SVMs) or the Adaboost algorithm.

The facial appearance similarity estimation module 26 obtains sparse representation by performing quantization on a human photo, and uses it to compute the appearance similarity between pairwise faces in the human photo database. In an actual implementation, this can be achieved by sparse representation of facial images with inverted index, and the sparse representation is computed through feature vectors.

The aesthetics assessment module 27 performs aesthetic assessment on the human photos in the human photo database to generate an aesthetic score of each photo. In this regard, the aesthetics assessment module 27 evaluates the aesthetic score of a human photo based on the color, the texture, the saliency and the edges of the photo. The aesthetic score does not influence the initial search results, but can be used for further filtering after the candidate photos are determined.

The above human attribute detection module 25 and the facial appearance similarity estimation module 26 produce human attribute scores and facial appearance similarity scores by analyzing people (or faces) in the photo, whereas the aesthetics assessment module 27 produces an aesthetic score by analyzing the entire photo. These scores can be incorporated into the block-based index to assist the search.

In addition, an aesthetic filtering module 24 performs filtering based on the aesthetic scores of the candidate photos, so the display module 23 displays only the candidate photos with aesthetic scores higher than a predetermined value. As discussed before, each human photo has its aesthetic score. After the candidate photos are ranked by the ranking module 22, the aesthetic filtering can be optionally applied to determine which photos are to be displayed, that is, photos with the aesthetic scores higher than a predetermined value, such that the display module 23 returns only those candidate photos with better aesthetic quality to the canvas interactive interface 10 for display.

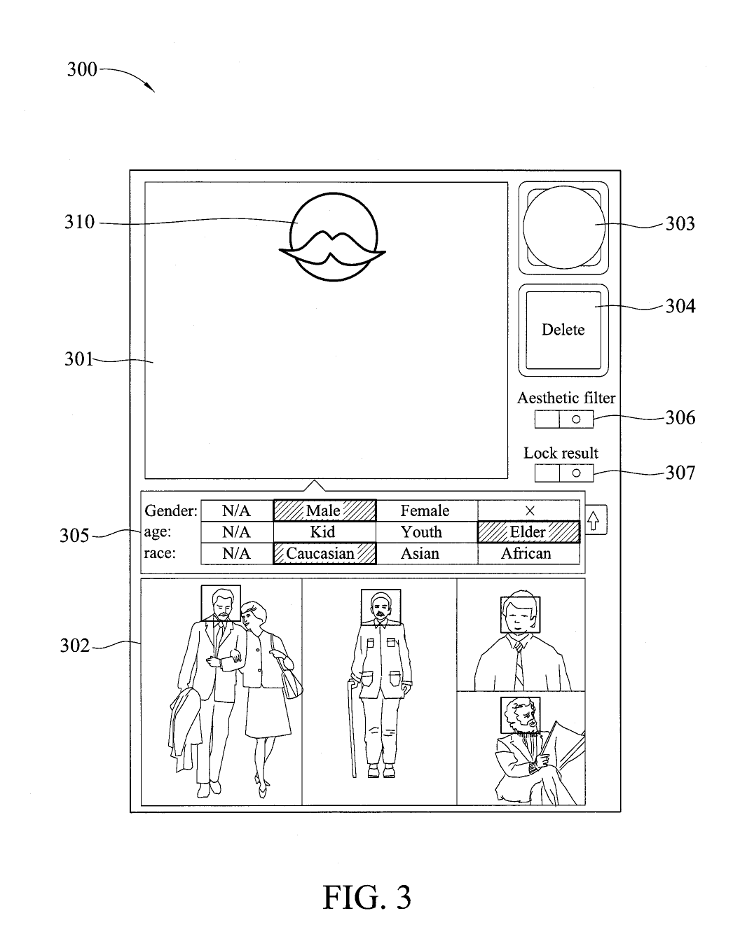

Referring to FIG. 3, a schematic diagram illustrating the canvas interactive interface of the human photo search system according to the present invention is shown. As shown in FIG. 3, a canvas interactive interface 300 is provided on a screen of the user device. The user may perform photo search on a cloud database via the canvas interactive interface 300. The canvas interactive interface 300 includes a query canvas area 301, a photo display area 302, an attribute selection area 305 and other operation control widgets.

On the right-hand side of the canvas interactive interface 300, a plurality of operation control widgets are provided, including icon addition 303, icon deletion 304, aesthetic filter 306, and lock result 307. The aspect ratio (height to width ratio) of the query canvas area 301 can be adjusted according to needs, so it matches the human photo in mind. The coordinates (x, y, w, h) of a person is represented relative to the width or height of the entire photo (not represented in pixels), so that a uniform comparison standard can be established across photos with different aspect ratios and resolutions.

In an actual implementation, if this is performed on a touch sensitive device, multi-touch gestures can be used. When a person is to be added or deleted, the user may drag out an icon from icon addition 303 or drag it into icon deletion 304. When a human icon 310 is in the query canvas area 301, the user may drag it to an appropriate position and pinch it to adjust its size, thereby forming an initial composition. At this time, it indicates that the position and the size of a person in a photo to be searched should match the position and the size indicated by the human icon 310 in the query canvas area 301. Thereafter, the user may hold the human icon 310 for a period of time, and the screen will display an attribute selection area 305. In this embodiment, gender, age and race can be selected by the user to assist the search. As shown in the drawing, the male, elder, and Caucasian options are selected, so the human icon 310 will immediate become a human icon with a mustache shape in white skin. Meanwhile, the photo display area 302 will display a collection of candidate photos after the search. In other words, after each editing, a search is immediately performed and displayed on the photo display area 302, and the user may examine to see if the desired photo has been found.

In addition, lock result 307 allows the user to temporarily freeze the displayed results. As mentioned before, the photo display area 302 immediately responds to a change in the query canvas area 301, so before composition is finished or when the user wishes to temporarily freeze the search results, he/she can use lock result 307 to pause the search. Moreover, aesthetic filter 306 allows the user to select whether to perform aesthetic filtering on the photos. When aesthetic filter 306 is enabled, only photos with higher aesthetic scores are displayed.

Thus, through the canvas interactive interface 300, the user is allowed to edit a photo to be searched/a photo with only a vague impression in the query canvas area 301, and the photo display area 302 may immediately display candidate photos, such that the user may gradually refine the query canvas to search for a desired photo.

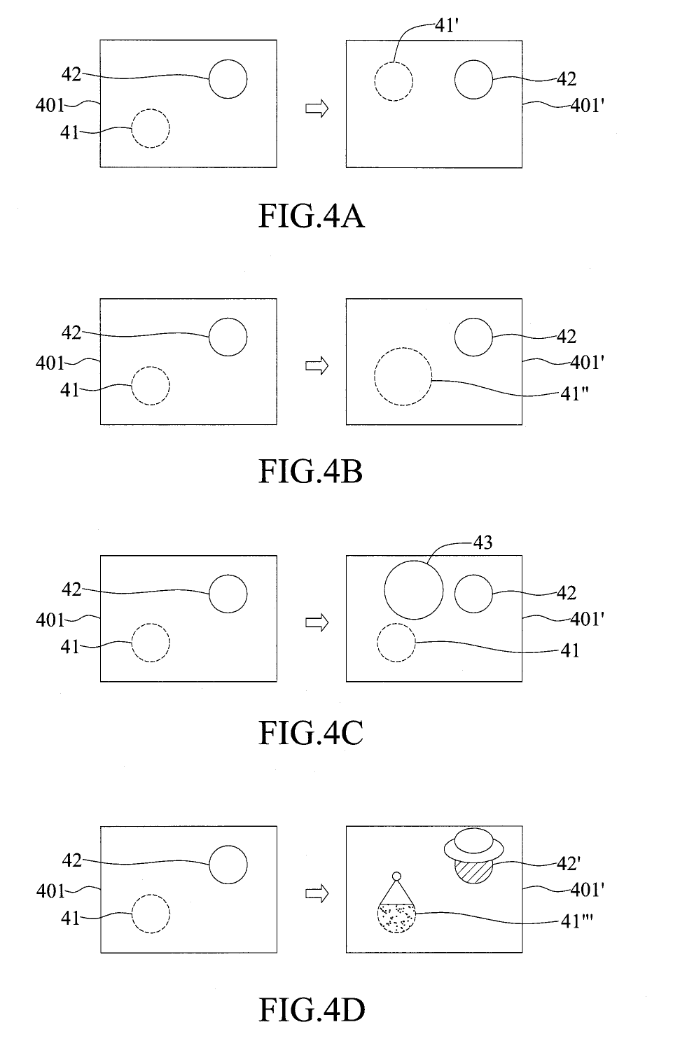

Referring to FIGS. 4A-4D, schematic diagrams illustrating various operations of the human photo search system according to the present invention are shown, and different operations in the query canvas area 301 of FIG. 3 are described as follows.

On the left-hand side of FIG. 4A, a human icon 41 and a human icon 42 have been edited in a query canvas area 401, wherein the human icon 41 is dragged by a finger to a position at an equal height (shown by human icon 41′ in the query canvas area 401′ on the right-hand side of FIG. 4A) to the human icon 42.

On the left-hand side of FIG. 4B, a human icon 41 and a human icon 42 have been edited in a query canvas area 401, wherein the size of the human icon 41 is enlarged by pinching with two fingers, as shown by human icon 41″ in the query canvas area 401′ on the right-hand side of FIG. 4B.

On the left-hand side of FIG. 4C, a human icon 41 and a human icon 42 have been edited in a query canvas area 401. If the user wishes to add a third person to the search criteria, a third icon is added through the icon addition 303 in FIG. 3, as shown by another human icon 43 between the human icon 41 and the human icon 42 in the query canvas area 401′ on the right-hand side of FIG. 4C.

FIGS. 4A-4C illustrate how the initial human layout of the desired photo can be constructed by adjusting the position and the size of the human icon 41 or adding the new human icon 43.

On the left-hand side of FIG. 4D, a human icon 41 and a human icon 42 have been edited in a query canvas area 401, and then the attributes such as gender, age, or race of the human icon 41 and the human icon 42 are selected through the attribute selection area 305 of FIG. 3. As shown in the query canvas area 401′ on the right-hand side of FIG. 4D, the colors of the human icon 41′″ and the human icon 42′ are changed to colors corresponding to different races, and the human icon 41′″ with kid's cap indicates the setting of a kid, whereas the human icon 42′ with a lady's hat indicates the setting of a female.

FIG. 4D illustrates that attributes of the human icon 41 and the human icon 42 in the query canvas area 401 are selected and used as a basis for searching a desired photo.

Moreover, in order to demonstrate the human photo search system of the present invention, different patterns of the query canvas and the corresponding search results (a)-(e) are provided in the annex. In the embodiment shown in the annex, facial searches are performed. For example, scenario (a) shows two human faces side by side; scenario (b) shows the combination of a young woman and a kid; scenario (c) shows three people side by side, but people on the left and right are of African race; scenario (d) shows that search by appearance similarity is directly based on an example image of a human face; and scenario (e) shows that the search is based on an example image of a human face in conjunction with a human face icon. Different search criteria result in different search results. The present system also provides ranking based on relevance, where a candidate with a higher relevance is ranked at the front for easy viewing by the user.

Furthermore, in an embodiment of the present invention, the user device and the photo search server are designed to be independent of each other, and they transfer data to each other through a network. This is based on the concept that a large number of photos are stored in a cloud database. However, the present invention can also integrate the user device with the photo search server into one apparatus, which similarly achieves the same photo searching technique mentioned above. For example, this apparatus can be placed in a photo gallery, allowing customers to find photos of interest from a large collection of photos. Thus, the apparatus separating the user device and the photo search server is merely an example of the present invention, and should not be construed as a limitation to the present invention.

Compared with the prior art, the present invention provides a human photo search system that can be used for searching photos between a user device and a cloud database. Through composing (layout editing and content setting) the user's impression of a desired photo, candidate photos can be found in a human photo database based on the search criteria, and are sorted by relevance, and/or are processed through an aesthetic filter to be displayed to the user. With the human photo search system of the present invention, a canvas interactive interface is used for composition, where a user simply needs to specify the human content and human layout of a person/people from his/her impression in order to find a matching candidate photo without entering any text tags. The human photo search system is also intuitive and easy to operate, providing users a new way of searching photos.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A human photo search system, comprising:
a user device including a canvas interactive interface, the canvas interactive interface including a query canvas area for allowing a user to compose human content and human layout therein to generate query semantics; and
a photo search server including:
a human photo database for storing a plurality of human photos and building a block-based index based on position and size information;
a search module for receiving the query semantics from the user device and retrieving candidate photos pointed to by the block-based index of the human photo database based on the query semantics;
a ranking module for generating a score for each of the candidate photos based on relevance, and sorting all of the candidate photos according to the scores therefor; and
a display module for returning the sorted candidate photos back to the user device.

2. The human photo search system of claim 1, wherein the human content includes at least one selected from the group consisting of gender, age, race, facial expression, hairstyle, and accessories.

3. The human photo search system of claim 1, wherein the human content further includes facial appearance similarity, whose source image is selected from the candidate photos or a facial photo input by the user.

4. The human photo search system of claim 1, wherein the human layout includes at least one selected from the group consisting of positions, sizes, angles, and the number of people in the query canvas area.

5. The human photo search system of claim 1, wherein the relevance takes into account errors between the query semantics generated by the query canvas and a candidate photo, the errors including human attributes, facial appearances, positions, sizes, angles, or the number of people.

6. The human photo search system of claim 1, wherein the block-based index further includes human attribute scores, facial appearance similarity scores, and photo aesthetic scores.

7. The human photo search system of claim 6, wherein the photo search server further includes a human attribute detection module for performing attribute detection on a person in the human photo to generate attribute scores of the person.

8. The human photo search system of claim 6, wherein the photo search server further includes a facial appearance similarity estimation module for obtaining a specific representation of a human face in the human photo to evaluate the facial appearance similarity between two faces.

9. The human photo search system of claim 6, wherein the photo search server further includes an aesthetics assessment module for performing aesthetics assessment on a human photo in the human photo database to generate an aesthetic score for the photo.

10. The human photo search system of claim 9, wherein the photo search server further includes an aesthetic filtering module that performs filtering on the aesthetic scores of the candidate photos, such that the display module displays only those candidate photos with aesthetic scores higher than a predetermined value.
